(19) United States
(12) Patent Application Publication
(10) Pub. No.: US 2003/0122361 A1
(43) Pub. Date: Jul. 3, 2003

(54) Seat restraint tension sensing assembly

(76) Inventors: Phillip E. Kaltenbacher II, Kokomo, IN (US); Morgan D. Murphy, Kokomo, IN (US); Stuart S. Sullivan, Peru, IN (US)

Correspondence Address: KATHRYN A. MARRA, DELPHI TECHNOLOGIES, INC., Legal Staff, Mail Code: 480-414-420, P.O. Box 5052, Troy, MI, 48007-5052, US

(21) Appl. No.: 10/037,801

(22) Filed: Jan. 3, 2002

(51) Int. Cl. B60R 22/00

(52) U.S. Cl. 280/801.1; 280/734

(57) ABSTRACT

A seat restraint tension sensing assembly for a seat restraint system in a vehicle includes a latch plate for connection to belt webbing of the seat restraint system. The seat restraint tension sensing assembly also includes a buckle assembly for receiving the latch plate. The seat restraint tension sensing assembly includes at least one magnet mounted to the latch plate and at least one Hall effect sensor associated with either one of the latch plate and the buckle assembly and cooperable with the at least one magnet. The seat restraint tension sensing assembly further includes a movable actuator mounted to the latch plate and cooperable with the belt webbing to move the at least one magnet relative to the at least one Hall effect sensor to change an output of the at least one Hall effect sensor to indicate a tension level in the seat restraint system.

### TECHNICAL FIELD

The present invention relates generally to seat restraint systems for vehicles and, more particularly, to a seat restraint tension sensing assembly for a seat restraint system in a vehicle.

### BACKGROUND OF THE INVENTION

It is known to provide a seat restraint system such as a seat belt in a vehicle to restrain an occupant in a seat of the vehicle. In some vehicles, the seat restraint system may be a lap belt, a shoulder belt, or both. Typically, the lap belt and shoulder belt are connected together at one end. The seat restraint system includes a latch plate at the connected end. The seat restraint system also includes a buckle connected at one end by webbing or the like to vehicle structure. The buckle receives the latch plate to be buckled together. When the buckle and latch plate are buckled together, the seat restraint system restrains movement of the occupant to help protect the occupant during a collision.

Smart inflatable restraint systems need to know what is occupying a seat of the vehicle. Decisions on deployment of inflatable restraints depend on information supplied by sensors in the seat in determining weight of an object in the seat. When a child seat is placed in the seat and cinched down, the sensors may read a large mass instead of a child seat. With this condition, there will be high tension in the seat restraint system. Comfort studies have shown that no human occupant would wear their seat restraint that tight. With this information on seat restraint tension, the inflatable restraint system can decide on deployment of the inflatable restraint.

Therefore, it is desirable to sense tension in a seat restraint of a seat restraint system of a vehicle. It is also desirable to provide seat restraint tension sensing for a seat restraint system in a vehicle that allows a control module to determine the difference between a child seat and a small occupant. It is further desirable to provide a tension sensing assembly for a seat restraint system in a vehicle that allows the sensing to occur on either the latch plate or buckle of the seat restraint system.

### SUMMARY OF THE INVENTION

It is, therefore, one object of the present invention to provide a seat restraint tension sensing assembly for sensing tension in a seat restraint system of a vehicle.

It is another object of the present invention to provide a seat restraint tension sensing assembly on a latch plate for sensing tension in a seat restraint system of a vehicle.

It is yet another object of the present invention to provide a seat restraint tension sensing assembly on a buckle for sensing tension in a seat restraint system of a vehicle.

To achieve the foregoing objects, the present invention is a seat restraint tension sensing assembly for a seat restraint system in a vehicle including a latch plate for connection to belt webbing of the seat restraint system. The seat restraint tension sensing assembly also includes a buckle assembly for receiving the latch plate. The seat restraint tension sensing assembly includes at least one magnet mounted to the latch plate and at least one Hall effect sensor associated with either one of the latch plate and the buckle assembly and cooperable with the at least one magnet. The seat restraint tension sensing assembly further includes a movable actuator mounted to the latch plate and cooperable with the belt webbing to move the at least one magnet relative to the at least one Hall effect sensor to change an output of the at least one Hall effect sensor to indicate a tension level in the seat restraint system.

One advantage of the present invention is that a seat restraint tension sensing assembly is provided for a seat restraint system in a vehicle. Another advantage of the present invention is that the seat restraint tension sensing assembly senses tension in the seat restraint system to help identify what is occupying the seat, either a child, child seat, or low mass adult. Yet another advantage of the present invention is that the seat restraint tension sensing assembly allows for optimal location of tension monitoring and communication of a resultant signal either through inductive coupling or direct measurement in the buckle or a magnet displacement in a tongue of the latch plate. Still another advantage of the present invention is that the seat restraint tension sensing assembly can perform a secondary function as seat latch indicators that are activated by coins placed in the buckle. A further advantage of the present invention is that the seat restraint tension sensing assembly has wire routing that follows industry practice and has improved electrical connection. Yet a further advantage of the present invention is that the seat restraint tension sensing assembly is mounted to a seat restraint buckle of the seat restraint system and provides seat belt latching verification and communication with seat belt tension sensing.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of seat restraint tension sensing assembly, according to the present invention, illustrated in operational relationship with a seat restraint system of a vehicle.

FIG. 2 is a fragmentary elevational view of the seat restraint tension sensing assembly of FIG. 1 illustrating a pre-latched condition.

FIG. 3 is a view similar to FIG. 2 illustrating the seat restraint tension sensing assembly in a latched condition having a low-tension condition and a high-tension condition.

FIG. 4 is a fragmentary elevational view of another embodiment, according to the present invention, of the seat restraint tension sensing assembly of FIG. 1 illustrating a pre-latched condition.

FIG. 5 is a view similar to FIG. 4 illustrating the seat restraint tension sensing assembly in a latched condition having a low-tension condition and a high-tension condition.

### DESCRIPTION OF THE PREFERRED EMBODIMENT

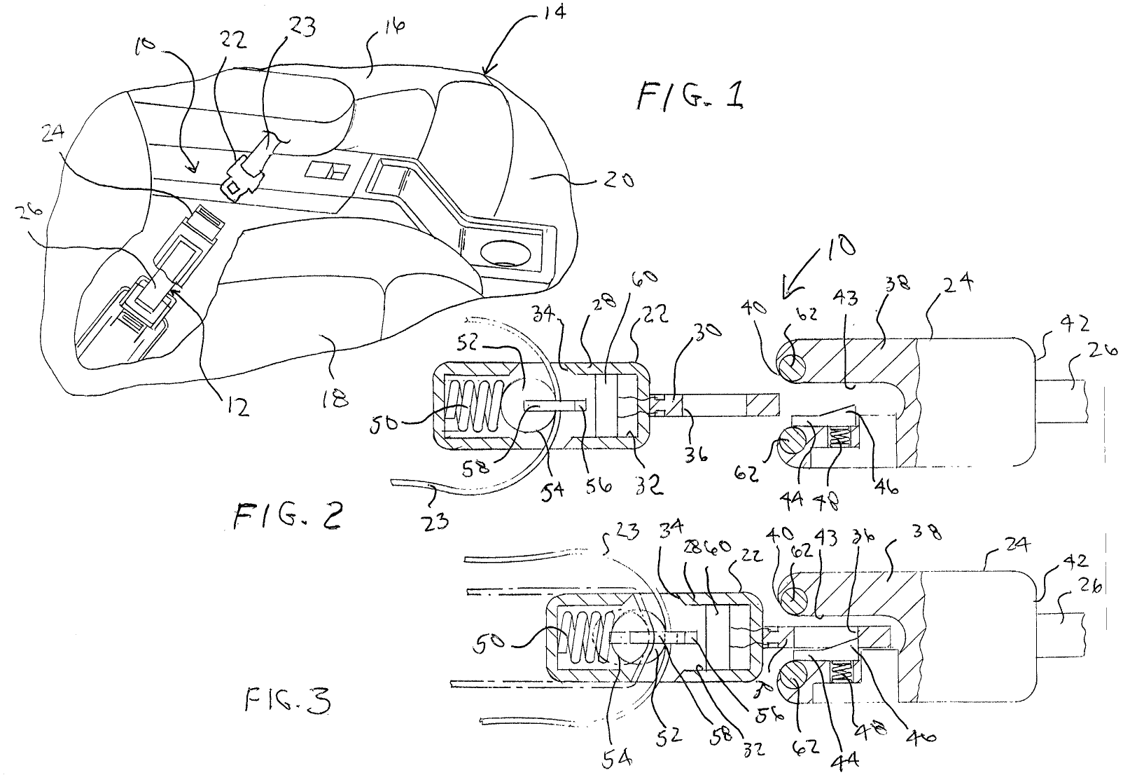

Referring to the drawings and in particular FIG. 1, one embodiment of a seat restraint tension sensing assembly 10, according to the present invention, is shown for a seat restraint system, generally indicated at 12, in a vehicle (partially shown), generally indicated at 14. The vehicle 14 includes a vehicle body 16 and a seat 18 mounted by suitable means to vehicle structure (not shown) such as a floorpan in an occupant compartment 20 of the vehicle body 16. In this embodiment, the seat 18 is a front seat of the vehicle 14. It should be appreciated that the seat 18 could be a rear, second row, or third row seat for the vehicle 14.

Referring to FIGS. 1 through 3, the vehicle 14 includes the seat restraint system 12 for restraining an occupant (not shown) in the seat 18. The seat restraint system 12 includes a latch tongue or plate 22 connected to an end of either one of a lap belt, shoulder belt, or both 23 which have another end connected to a retractor (not shown). The seat restraint system 12 also includes a buckle assembly 24 connected by suitable means such as belt webbing 26 to vehicle structure. It should be appreciated that the latch plate 22 is engageable and disengageable with the buckle assembly 24. It should also be appreciated that, except for the seat restraint tension sensing assembly 10, the seat restraint system 12 and vehicle 14 are conventional and known in the art.

Referring to FIGS. 1 through 3, the seat restraint tension sensing assembly 10, according to the present invention, includes the latch plate 22 and buckle assembly 24. The latch plate 22 has a housing portion 28 and a tongue portion 30 extending longitudinally from the housing portion 28. The housing portion 28 has a cavity 32 therein and an aperture 34 extending therethrough and communicating with the cavity 32 to allow belt webbing of the seat belt 23 to extend therethrough. The tongue portion 30 is generally rectangular in shape and has an aperture 36 extending therethrough and is engageable and disengageable with the buckle assembly 24. The housing portion 28 and tongue portion 30 are made of a rigid material such as metal. It should be appreciated that the housing portion and tongue portion 30 are a monolithic structure being integral, unitary, and one-piece.

The buckle assembly 24 has a housing 38 with an open forward end 40 and an opposite rearward end 42 attached to the belt webbing 26. The buckle assembly 24 also includes a release or push button (not shown) slidably mounted to the housing 38 for movement with respect thereto. The release button is spaced so as to define a rectangular slot-like passage 43 therebetween at the open forward end 40 of the housing 38, to allow access of the latch plate 22 into the buckle assembly 24. The buckle assembly 24 includes a movable latching pawl or locking member 44 connected to the housing 38. The locking member 44 moves between a latched or buckled position of FIG. 3 in which an integral dependent lock bar 46 engages or is disposed in the aperture 36 of the latch plate 22 and an unlatched or unbuckled position of FIG. 2 in which the lock bar 46 is disposed out of or disengages the aperture 36 in the latch plate 22. The buckle assembly 24 also includes a spring 48 such as a helical coil spring which is located between the locking member 44 and the housing 38 to urge the lock bar 46 into the passage 43 provided for the latch plate 22. It should be appreciated that the buckle assembly 24 may be similar to that disclosed in U.S. Pat. No. 5,271,129 to Clarke et al.

The seat restraint tension sensing assembly 10 includes at least one, preferably a plurality of springs 50 disposed in the cavity 32 of the housing portion 28 of the latch plate 22. The springs 50 are of a coil type. The springs 50 cooperate with an actuator 52 to be described and are arranged to provide balance to the actuator 52. The springs 50 are made of a spring material. The springs 50 are tuned to a predetermined force such as for comfort or low tension in the seat restraint system 12. The springs 50 may also be of a leaf type. It should be appreciated that the springs 50 are arranged to prevent internal tipping of the actuator 52.

The seat restraint tension sensing assembly 10 includes a movable actuator 52 disposed in the cavity 32 of the housing portion 28 adjacent the springs 50 for cooperating with the springs 50. The actuator 52 is generally cylindrical in shape and extends laterally. The actuator 52 has an outer surface 54 having a generally arcuate shape to contact the belt webbing 23. The actuator 52 is made of a rigid material such as plastic. It should be appreciated that, as the tension is increased in the belt webbing 23, the contact force of the actuator 52 increases. It should also be appreciated that actuator 52 moves as the springs 50 are compressed.

The seat restraint tension sensing assembly 10 includes at least one, preferably a plurality of magnets 56 disposed in the cavity 32 of the housing portion 28. The magnets 56 are connected to a carrier 58 extending longitudinally from the actuator 52. The seat restraint tension sensing assembly 10 includes at least one, preferably a plurality of Hall effect sensors 60 disposed in the cavity 32 of the housing portion 28 and spaced longitudinally from the magnets 56. The seat restraint tension sensing assembly 10 includes at least one, preferably a plurality of transmission or inductive coils 62 disposed at the open forward end 40 of the housing 38 of the buckle assembly 24 for a function to be described. It should be appreciated that the actuator 52 compresses the springs 50 and this motion moves the magnets 56 farther away from the Hall effect sensors 60 in a push-push arrangement. It should also be appreciated that the position of the magnets 56 relative to the Hall effect sensors 60 changes the output current of the Hall effect sensors 60. It should further be appreciated that the Hall effect sensors 60 are mounted on a circuit board (not shown) connected to the housing portion 28 and are potted and connected by electrical leads or wires to a source of power such as a modulator circuit for power coupling the Hall effect sensors 60.

In operation of the seat restraint tension sensing assembly 10, when the latch plate 22 is not latched with the buckle assembly 24 as illustrated in FIG. 2, no signal is transmitted by the Hall effect sensors 60. It should be appreciated that the actuator 52 of the seat restraint tension sensing assembly 10 is spring loaded to an initial position by the springs 50.

When the occupant buckles the seat restraint system 12, the tension in the belt webbing 23 may be lower than a predetermined load required to deflect the springs 50 as illustrated by the solid lines in FIG. 3. In this state, the coils 62 in the buckle assembly 24 inductively transmit power to the electronics in the tongue portion 30 of the latch plate 22, causing a controller (not shown) to determine that a normal or large mass adult is present in the seat 18. It should be appreciated that the seat restraint system 12 is in a low-tension condition as illustrated by the solid lines in FIG. 3.

When a child seat (not shown) is placed in the seat 18 and the seat restraint system 12 is buckled, the seat belt webbing 23 is cinched to pull the child seat tightly into the seat 18. As the tension is increased in the seat belt webbing 23, the contact force on the actuator 52 increases. The resistive force of the springs 50 reacts against the increased tension. When the tension in the belt webbing 23 is higher than the predetermined load, the actuator 52 moves as the springs 50 are compressed, thereby moving the magnets 56 farther away from the Hall effect sensors 60 in a push-push-arrangement for a high tension condition as illustrated by the phantom lines in FIG. 3. This changes the output of the Hall effect sensors 60, causing the controller to determine that a child seat is present in the seat 18. Depending upon the force applied to the belt webbing 23, the tongue portion 30 will modulate the signal from the supply side. The coils 62 in the buckle assembly 24 read the modulated signal to infer seat belt tension. It should be appreciated that the seat restraint tension sensing assembly 10 inductively couples to supply voltage and returns the signal from the buckle assembly 24 to the tongue portion 30 of the latch plate 22. It should also be appreciated that an audible tone or visual indication may be provided when the tension in the belt webbing 23 is increased above a predetermined level. It should further be appreciated that, in another embodiment, the movement of the carrier 58 can be used to create an eccentric rotation of the magnets 56 that modulates the strength of the induced field from the coils 62 located in the buckle assembly 24.

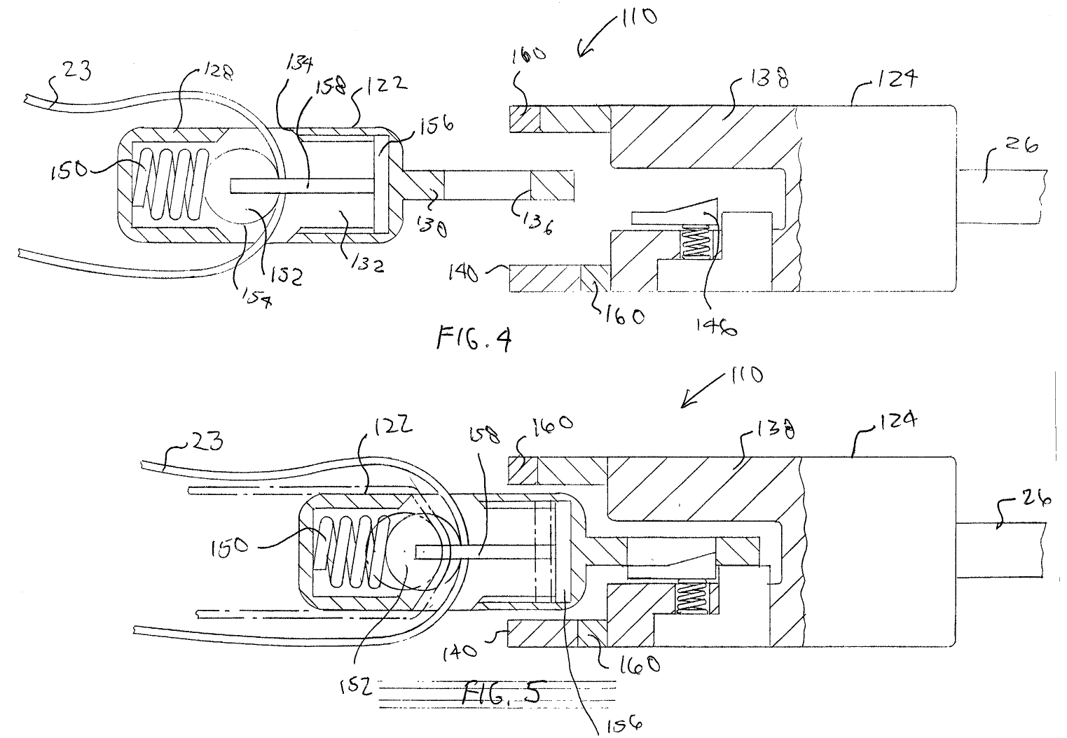

Referring to FIGS. 4 and 5, another embodiment, according to the present invention, of the seat restraint tension sensing assembly 10 is illustrated. Like parts of the seat restraint tension sensing assembly 10 have like reference numerals increased by one hundred (100). In this embodiment, the seat restraint tension sensing assembly 110 eliminates the inductive coils and includes the Hall effect sensors 160 in the open forward end 140 of the housing 138 of the buckle assembly 124. The seat restraint tension sensing assembly 110 also includes the magnets 156 connected to a slider 158, which is connected to the actuator 152. It should be appreciated that the Hall effect sensors 160 are mounted on a circuit board (not shown) connected to the housing 138 and are potted and connected by electrical leads or wires to a source of power such as a modulator circuit for power coupling the Hall effect sensors 160. It should also be appreciated that the magnets 156 are arranged in a slide by configuration, which will result in adequate output.

In operation of the seat restraint tension sensing assembly 110, when the latch plate 122 is not latched with the buckle assembly 124 as illustrated in FIG. 4, no signal is transmitted by the Hall effect sensors 160. It should be appreciated that the actuator 152 of the seat restraint tension sensing assembly 110 is spring loaded to an initial position by the springs 150.

When the occupant buckles the seat restraint system 12, the tension in the belt webbing 23 may be lower than a predetermined load required to deflect the springs 150 as illustrated by the solid lines in FIG. 5. In this state, the Hall effect sensors 160 and the magnets 156 are disposed next to one another, causing the controller to determine that a normal or large mass adult is present in the seat 18. It should be appreciated that the seat restraint system 12 is in a low-tension condition.

When a child seat (not shown) is placed in the seat 18 and the seat restraint system 12 is buckled, the seat belt webbing 23 is cinched to pull the child seat tightly into the seat 18. As the tension is increased in the seat belt webbing 23, the contact force on the actuator 152 increases. The resistive force of the springs 150 reacts against the increased tension. When the tension in the belt webbing 23 is higher than the predetermined load, the actuator 152 and slider 154 move as the springs 150 are compressed, thereby moving the magnets 156 farther away from the Hall effect sensors 160 in a push-push arrangement for a high tension condition as illustrated by the phantom lines in FIG. 5. The relative distance between the magnets 156 and the Hall effect sensors 160 changes the output of the Hall effect sensors 160. Changes in the output of the Hall effect sensors 160 result in corresponding changes of voltage that is transferred to the controller, causing the controller to determine that a child seat is present in the seat 18. It should be appreciated that the seat restraint tension sensing assembly 110 places magnets 156 in the latch plate 122 and the magnets 156 are displaced in response to the tension in the seat belt webbing 23. It should also be appreciated that an audible tone or visual indication may be provided when the tension in the belt webbing 23 is increased above a predetermined level.

Accordingly, in the seat restraint tension sensing assembly 110, resistance to increased seat belt tension results in the movement of the slider 158 containing the magnets 156 of the latch plate 122. This movement results in changes in the output of the Hall effect sensors 160 located in the buckle assembly 124. It should be appreciated that, in another embodiment, a triangular shaped ferrous piece is moved in and out in response to tension of the seat belt webbing 23.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A seat restraint tension sensing assembly for a seat restraint system in a vehicle comprising:
a latch plate for connection to belt webbing of the seat restraint system;
a buckle assembly for receiving said latch plate;
at least one magnet mounted to said latch plate;
at least one Hall effect sensor associated with either one of said latch plate and said buckle assembly and cooperable with said at least one magnet; and
a movable actuator mounted to said latch plate and cooperable with the belt webbing to move said at least one magnet relative to said at least one Hall effect sensor to change an output of said at least one Hall effect sensor to indicate a tension level in the seat restraint system.

2. A seat restraint tension sensing assembly as set forth in claim 1 wherein said latch plate comprises a housing portion and a tongue portion.

3. A seat restraint tension sensing assembly as set forth in claim 2 wherein said housing portion includes a cavity therein and an aperture extending therethrough and communicating with said cavity to allow seat belt webbing to pass therethrough.

4. A seat restraint tension sensing assembly as set forth in claim 3 wherein said actuator is disposed in said cavity.

5. A seat restraint tension sensing assembly as set forth in claim 3 including at least one spring disposed in said cavity between said actuator and a wall of said housing portion.

6. A seat restraint tension sensing assembly as set forth in claim 3 including a carrier disposed in said cavity and interconnecting said actuator and said at least one magnet.

7. A seat restraint tension sensing assembly as set forth in claim 3 wherein said at least one Hall effect sensor is disposed in said cavity and spaced longitudinally from said at least one magnet.

8. A seat restraint tension sensing assembly as set forth in claim 3 wherein said buckle assembly has a an open forward end and said at least one Hall effect sensor is located in said open forward end of said buckle assembly.

9. A seat restraint tension sensing assembly as set forth in claim 3 wherein said buckle assembly has an open forward end and at least one inductive coil is located in said open forward end of said buckle assembly.

10. A seat restraint tension sensing assembly as set forth in claim 3 including wherein said tongue portion has an aperture extending therethrough and said buckle assembly has a locking member to engage said aperture.

11. A seat restraint tension sensing assembly as set forth in claim 3 wherein said actuator extends laterally and is disposed in said cavity and has an arcuate outer surface adapted to engage the belt webbing.

12. A seat restraint tension sensing assembly for a seat restraint system in a vehicle comprising:
a latch plate having a tongue portion and a housing portion for allowing belt webbing of the seat restraint system to pass therethrough;
a buckle assembly for receiving said tongue portion of said latch plate;
at least one spring disposed within said housing portion;
at least one magnet disposed within said housing portion;
at least one Hall effect sensor associated with either one of said latch plate and said buckle assembly and cooperable with said at least one magnet; and
a movable actuator disposed within said housing portion and cooperable with the belt webbing and said at least one spring to move said at least one magnet relative to said at least one Hall effect sensor to change an output of said at least one Hall effect sensor to indicate a tension level in the seat restraint system.

13. A seat restraint tension sensing assembly as set forth in claim 12 wherein said housing portion includes a cavity therein and an aperture extending therethrough and communicating with said cavity to allow the belt webbing to pass therethrough.

14. A seat restraint tension sensing assembly as set forth in claim 13 wherein said actuator is disposed in said cavity and said at least one spring is disposed in said cavity between said actuator and a wall of said housing portion.

15. A seat restraint tension sensing assembly as set forth in claim 14 including a slider disposed in said cavity and interconnecting said actuator and said at least one magnet.

16. A seat restraint tension sensing assembly as set forth in claim 13 wherein said at least one Hall effect sensor is disposed in said cavity and spaced longitudinally from said at least one magnet.

17. A seat restraint tension sensing assembly as set forth in claim 13 wherein said buckle assembly has an open forward end and said at least one Hall effect sensor is located in said open forward end of said buckle assembly.

18. A seat restraint tension sensing assembly as set forth in claim 13 wherein said buckle assembly has an open forward end.

19. A seat restraint tension sensing assembly as set forth in claim 18 including at least one inductive coil located in said open forward end of said buckle assembly.

20. A seat restraint system for a vehicle comprising:
a seat restraint webbing;
a latch plate having a tongue portion and a housing portion, wherein said housing portion includes a cavity therein and an aperture extending therethrough and communicating with said cavity to allow said seat restraint webbing to pass therethrough;
a buckle assembly for receiving said tongue portion of said latch plate;
a plurality of springs disposed within said cavity;
a plurality of magnets disposed within said cavity;
a plurality of Hall effect sensors associated with either one of said latch plate and said buckle assembly and cooperable with said magnets; and
a movable actuator disposed within said cavity and cooperable with said seat restraint webbing and said springs to move said magnets relative to said Hall effect sensors to change an output of said Hall effect sensors to indicate a tension level in the seat restraint system.
